(19) United States
(12) Patent Application Publication
(10) Pub. No.: US 2026/0225741 A1
(43) Pub. Date: Aug. 6, 2026

(54) PROPULSION DEVICE

(71) Applicant: HITACHI, LTD., Chiyoda-ku, Tokyo (JP)

(72) Inventors: Kisho ASHIDA, Tokyo (JP); Yasuki KITA, Tokyo (JP); Nobuo NAMURA, Tokyo (JP); Hironobu YAMAKAWA, Tokyo (JP)

(21) Appl. No.: 19/150,775

(22) PCT Filed: Dec. 20, 2023
(86) PCT No.: PCT/JP2023/045811

§ 371 Date: Jul. 24, 2025

(30) Foreign Application Priority Data
May 17, 2023 (JP) 2023-081514

(51) Int. Cl. B64U 20/94; B64U 20/96; B64U 50/19; F04D 19/00; F04D 29/32

(52) U.S. Cl. CPC B64U 20/94; B64U 20/96; B64U 50/19; F04D 19/002; F04D 29/329

(57) ABSTRACT

An object of the invention is to provide, for a flying object such as a drone or an eVTOL, a propulsion device including a motor and a fan including a plurality of blades and a hub portion, and configured to implement cooling of the motor while ensuring structural reliability of the fan. Therefore, in a propulsion device 1 including a motor 3, a rotation shaft 17 driven by the motor 3, and a fan 2 attached to the rotation shaft 17, the fan 2 includes a hub portion 5 attached to the rotation shaft 17 and a plurality of blades 4 provided at equal intervals on an outer periphery of the hub portion 5, the hub portion 5 has a plurality of hole portions 6 arranged at equal intervals in a circumferential direction of the hub portion 5, and at least a part of side surfaces of the plurality of hole portions 6 is sloped with respect to a center axis of the rotation shaft 17.

### TECHNICAL FIELD

The present invention relates to a technique effective when applied to a fan structure of a propulsion device used in flying objects such as a drone and an electric vertical take-off and landing (eVTOL) which is an air mobility capable of vertical take-off and landing.

### BACKGROUND ART

In recent years, attention is focused on flying objects such as drones for distribution of goods and an eVTOL. Since such a flying object does not require a runway, there is a possibility that the flying object can implement low altitude flight in an urban area, and a market scale thereof is expected to expand in the future.

As a background art related to a fan structure mounted on a propulsion device of such a flying object, for example, there is a technique as disclosed in PTL 1. FIG. 3 and the abstract of PTL 1 disclose that the problem is “to provide a flying object capable of appropriately preventing a temperature rise of an electric component unit and extending a life of the flying object”, and the solution is that “A flying object (drone) includes a main body portion 11, a plurality of frame portions 12 extending from the main body portion 11, a propulsion drive unit 20 including rotor blades (propellers) 22 provided at tip end portions of the frame portions 12 and a motor 21 that rotates the rotor blades 22, an electric component unit for driving the propulsion drive unit 20, and a blower fan 24 coupled to a rotation shaft of the motor 21 below the rotor blades 22 and rotated by the motor 21. The frame portion 12 is a hollow member having a space inside, and has a plurality of air supply and exhaust ports communicating the space with the outside, and the electric component unit is disposed between at least two air supply and exhaust ports in the space of the frame portion 12. The blower fan 24 takes external air into the space from at least one air supply and exhaust port.”

Further, as a background art related to a fan structure for a vehicle although not for a flying object, there is a technique as in PTL 2. FIG. 2 and the abstract of PTL 2 disclose that the problem is “to provide a configuration capable of preventing accumulation of dust inside a boss portion for a blower fan having the boss portion in a center portion”, and the solution is that “A ventilation hole 85 penetrating along an extending direction of a rotation shaft 62 of an electric motor 6 is provided in a boss portion 8 of a blower fan 7, and in the boss portion 8, an attachment portion 81 attached to the rotation shaft 62 of the electric motor 6 and a tubular portion 82 provided on an outer peripheral side of the attachment portion 81 and in which the electric motor 6 is disposed are coupled by a coupling portion including an inner blower blade 83.”

### CITATION LIST

### Patent Literature

PTL 1: JP2020-131781A
PTL 2: JP2019-108872A

### SUMMARY OF INVENTION

### Technical Problem

When flying a flying object in the urban area, it is important to reduce noise of the fan mounted on the propulsion device. One of main factors of the noise of the fan is peak noise fBPF referred to as a blade passing frequency (BPF). In order to prevent the peak noise fBPF, it is conceivable to shift the fBPF to a high frequency side where hearing sensitivity decreases. Since fBPF is expressed by fBPF=Z·N/60, where Z is the number of blades and N is a rotation speed of the fan, the fBPF can be shifted to the high frequency side by simply increasing Z or N. On the other hand, in order to prevent a shock wave due to an increase in a blade end peripheral speed, it is necessary to reduce a fan diameter. As described above, in order to reduce the noise of the fan, it is necessary to develop a small-diameter, high-speed, multi-blade fan structure. A structure in which a large number of such fans are arranged in parallel is used for the flying object.

Next, the problem will be described. In the case of such a small-sized multi-blade fan structure, the blades may overlap to each other in a root region of the blade (that is, a region near a hub portion to which the blade is connected). In this case, when the fan rotates, air does not flow from an upper surface side to a lower surface side of the blade in the root region of the blade, resulting in a problem of deteriorating cooling performance of the motor installed on the same rotation shaft as the fan. Further, even when the blades do not overlap each other as described above, projection planes of the blades may overlap each other in a plan view from an upper surface of the fan. In this case, when manufacturing by molding using a resin material such as carbon fiber reinforced plastics (CFRP) is assumed, it is difficult to release a mold, and thus there is a problem in that molding excellent in mass productivity cannot be applied.

In the flying object of PTL 1, since the rotor blades and the blower fan are separately formed, there is difficulty in assembling. On the other hand, the blower fan described in PTL 2 can cool the motor by blowing air by an inner peripheral side blower blade, but has a structure in which a space between an outer peripheral side blower blade and the rotation shaft is supported by the inner peripheral side blower blade (does not include the hub portion), and thus cannot withstand a stress load during high-speed rotation (has low structural reliability).

Therefore, an object of the invention is to provide, for a flying object such as a drone or an eVTOL, a propulsion device including a motor and a fan including a plurality of blades and a hub portion, and configured to implement cooling of the motor while ensuring structural reliability of the fan.

### Solution to Problem

In order to solve the above problem, the invention provides a propulsion device including a motor, a rotation shaft driven by the motor, and a fan attached to the rotation shaft, in which the fan includes a hub portion attached to the rotation shaft and a plurality of blades provided on an outer periphery of the hub portion, the hub portion has a plurality of hole portions arranged at equal intervals in a circumferential direction of the hub portion, and at least a part of side surfaces of the plurality of hole portions is sloped with respect to the rotation shaft.

### Advantageous Effects of Invention

According to the invention, it is possible to provide, for a flying object such as a drone or an eVTOL, a propulsion device including a motor and a fan including a plurality of blades and a hub portion, and configured to implement cooling of the motor while ensuring structural reliability of the fan. Problems, configurations, and effects other than those described above will be clarified by the following description of embodiments.

### BRIEF DESCRIPTION OF DRAWINGS

FIG. 1 is a top view of a fan to be mounted on a propulsion device according to Embodiment 1.

FIG. 2 is a cross-sectional view taken along a line A-B in FIG. 1.

FIG. 3 is a perspective view of the propulsion device according to Embodiment 1.

FIG. 4 is a schematic top view of a flying object to which the propulsion device according to Embodiment 1 is applied.

FIG. 5 is a top view of a fan to be mounted on a propulsion device according to Embodiment 2.

FIG. 6 is a top view of a fan to be mounted on a propulsion device according to Embodiment 3.

### DESCRIPTION OF EMBODIMENTS

Hereinafter, embodiments of the invention will be described with reference to the drawings. In each of the drawings and each of the embodiments, the same or similar components are denoted by the same reference numerals, and redundant description thereof is omitted.

### Embodiment 1

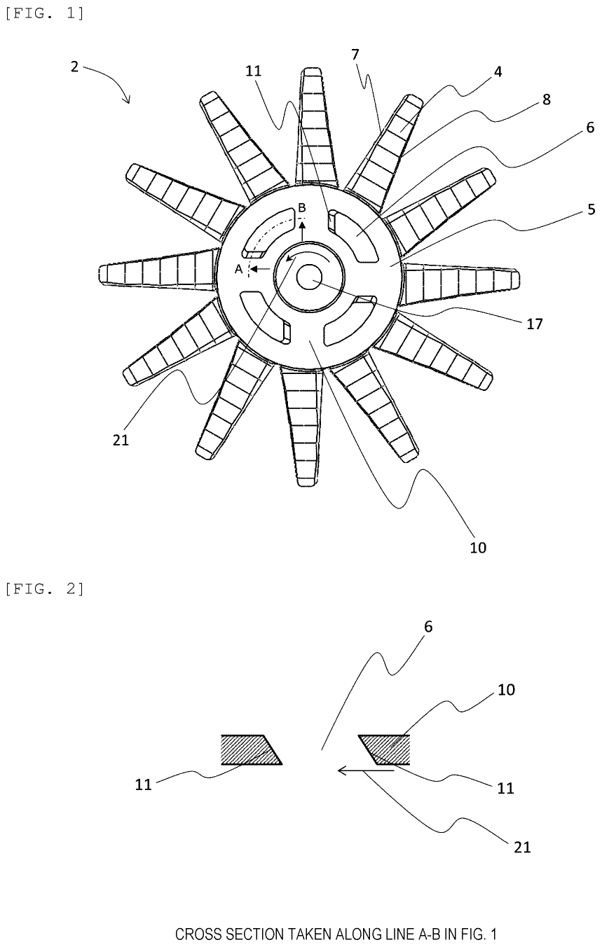

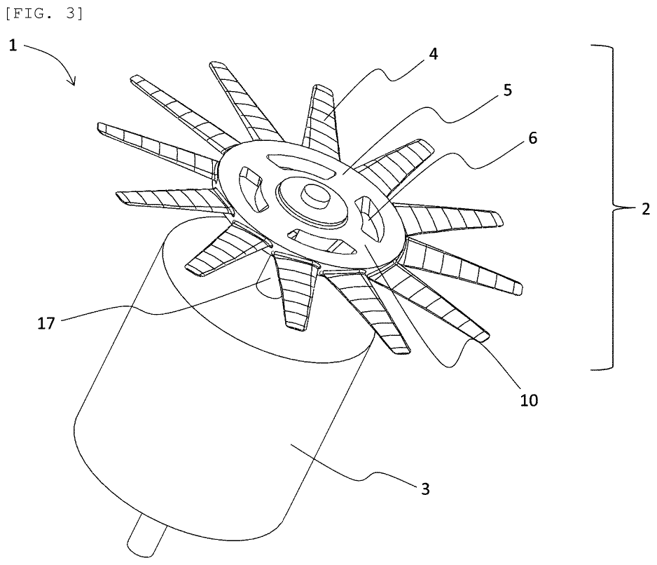

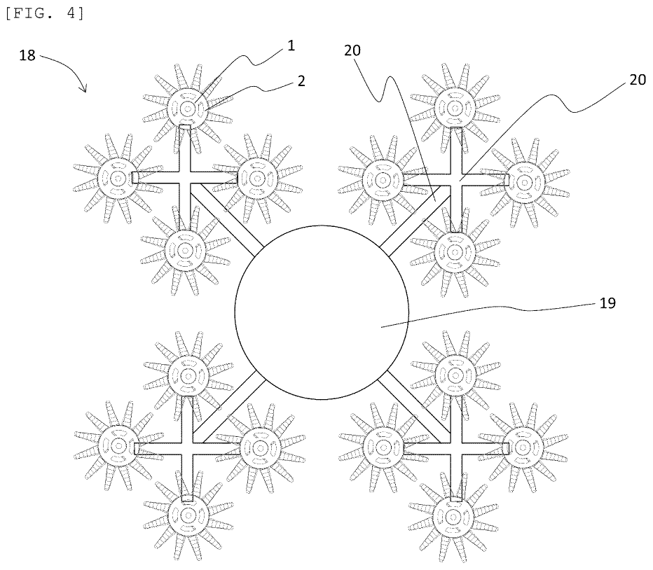

FIG. 1 is a top view of a fan 2 of a propulsion device 1 to be mounted on a flying object 18 according to Embodiment 1. FIG. 2 is a cross-sectional view taken along a line A-B in FIG. 1. FIG. 3 is a perspective view of the propulsion device 1 including the fan 2 and a motor 3. FIG. 4 is a schematic top view of the flying object 18 on which the plurality of propulsion devices 1 are mounted. As a result of studies by the inventors, it has been found that as one of feasible fan structure proposals, a structure having the number of blades Z=12, a rotation speed N=40000 rpm, and a fan diameter=100 mm is conceivable. Hereinafter, this structure will be described as a basic structure.

As shown in FIG. 4, the flying object 18 includes a loading portion 19, a frame 20, a plurality of propulsion devices 1, and a control device portion (not shown). As shown in FIG. 3, the propulsion device 1 includes the fan 2 and the motor 3. Similarly to the known technology described in the background art, the flying object 18 generates a dynamic lift by a descending air current by driving the motor 3 to rotate the fan 2, floats in the air, and flies. The frame 20 is made of, for example, a CFRP resin material for the purpose of weight reduction. A plurality of propulsion devices 1 are mounted on a tip end of the frame 20. As described in the technical problem, the fan of the invention is characterized by being small-sized. In a known drone or eVTOL, four propulsion devices are generally installed, but in the invention, more than four propulsion devices are installed. Although FIG. 4 shows a diagram in which 16 propulsion devices 1 are installed, the number of propulsion devices 1 may be other than 16.

As shown in FIG. 3, the propulsion device 1 is a unit that generates a thrust for the flight of the flying object 18, and includes the motor 3 installed on a rotation shaft 17 and the fan 2 rotated by the motor 3. A rotation speed of the motor is controlled by a control device (not shown).

As shown in FIG. 1, the fan 2 according to Embodiment 1 includes a hub portion 5 having a disk shape around the rotation shaft 17, and 12 blades 4 are connected to the hub portion 5. The number of blades is not limited to 12, and may be other multiples. A material of the fan 2 is a metal material such as an aluminum alloy or a resin material such as CFRP. The material of the fan 2 may be a combination of a plurality of materials. The blades 4 are arranged uniformly in a circumferential direction. When the fan 2 is viewed in a plan view from above, projection planes of the blades 4 do not overlap one another.

The hub portion 5 is provided with a plurality of hole portions 6 penetrating in a vertical direction. The hole portions 6 are arranged uniformly in the circumferential direction. Beam portions 10 each are formed between the hole portions 6. The fan 2 generates a thrust by rotating in a counterclockwise direction about the rotation shaft 17. The blade 4 includes a blade leading edge 7 and a blade trailing edge 8. FIG. 2 is a cross-sectional view taken along the line A-B in FIG. 1. FIG. 2 is a cross-sectional view in the circumferential direction including the hole portion 6 and the beam portion 10. As shown in FIG. 2, a side surface of the hole portion 6 has a sloped surface portion 11. An angle formed by a rotation direction 21 and the sloped surface portion 11 is an acute angle. This is because when the fan 2 rotates, air is taken in from the hole portions 6 to cool the motor 3 installed below the fan 2. In FIG. 2, the sloped surface portions 11 are provided on two side surfaces of the hole portion 6, but a sloped surface may be provided on only one side surface.

In the present embodiment, the two side surfaces of the hole portion 6 are sloped toward the rotation direction 21 of the fan 2 with respect to a center axis of the rotation shaft 17. Accordingly, an amount of air passing through the hole portion 6 when the fan 2 rotates can be increased. The side surface of the hole portion 6 may be sloped toward a radial direction of the fan 2. Even in this case, air can be taken in via the hole portion 6 during horizontal flight of the flying object 18. However, the amount of air passing through the hole portion 6 in the case in which the side surface of the hole portion 6 is sloped toward the rotation direction 21 is significantly larger than that in the case in which the side surface of the hole portion 6 is sloped toward the radial direction of the fan 2.

Next, effects of the present structure will be described. As shown in FIGS. 1 and 2, the hole portions 6 are provided in the circumferential direction of the hub portion 5 and the sloped surface portions 11 are provided on the side surfaces of the hole portions 6. Therefore, when the fan 2 rotates, air can be taken in from the hole portions 6, and thus motor cooling can be implemented. In addition, when the fan 2 is viewed in a plan view from above, the projection planes of the blades 4 do not overlap one another. In this case, assuming that the fan is manufactured by molding using a resin material such as CFRP, a mold can be released, and thus the fan can be manufactured by molding with excellent mass productivity.

### SUMMARY

In Embodiment 1, in the propulsion device 1 including the motor 3, the rotation shaft 17 driven by the motor 3, and the fan 2 attached to the rotation shaft 17, the fan 2 includes the hub portion 5 attached to the rotation shaft 17 and the plurality of blades 4 provided at equal intervals on an outer periphery of the hub portion 5, the hub portion 5 includes the plurality of hole portions 6 arranged at equal intervals in the circumferential direction of the hub portion 5, and at least a part of the side surfaces of the plurality of hole portions 6 is sloped with respect to the center axis of the rotation shaft 17.

According to Embodiment 1 having the configuration as described above, since the plurality of blades 4 are provided on the outer periphery of the hub portion 5, structural reliability of the fan 2 can be ensured. Further, since at least a part of the side surfaces of the plurality of hole portions 6 is sloped with respect to the center axis of the rotation shaft 17, air can be taken in the motor 3 via the hole portions 6 when the fan 2 rotates. Accordingly, cooling of the motor 3 can be implemented.

Further, in Embodiment 1, at least a part of the side surfaces of the plurality of hole portions 6 is sloped toward the rotation direction 21 of the fan 2 with respect to the center axis of the rotation shaft 17. Accordingly, the amount of air passing through the hole portion 6 when the fan 2 rotates can be increased, and thus cooling performance of the motor 3 can be improved.

In Embodiment 1, a cross-sectional area of the beam portion 10 in the circumferential direction of the hub portion 5 is set such that a stress generated in the beam portion 10, which is a portion of the hub portion 5 sandwiched between two adjacent hole portions 6 among the plurality of hole portions 6, is smaller than a stress generated in the plurality of blades 4. Accordingly, the structural reliability of the fan 2 can be improved.

In Embodiment 1, when the fan 2 is projected onto a plane perpendicular to the rotation shaft 17, the projection planes of two adjacent blades 4 among the plurality of blades 4 do not overlap each other. Accordingly, it is possible to manufacture the fan 2 by applying molding, which is excellent in mass productivity.

### Embodiment 2

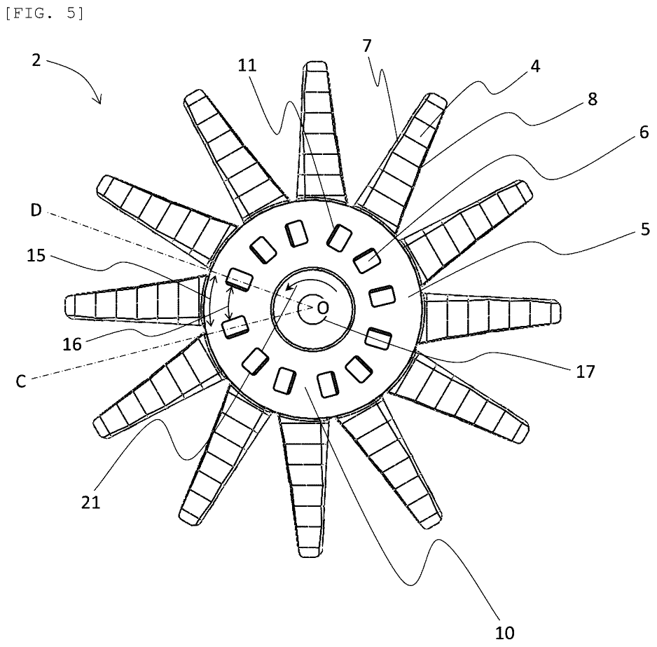

FIG. 5 is a top view of the fan 2 of the propulsion device 1 according to Embodiment 2 to be mounted on the flying object 18. The configuration other than the fan 2 is the same as that of Embodiment 1 (shown in FIGS. 2 to 4).

As shown in FIG. 5, the fan 2 according to Embodiment 2 includes the hub portion 5 having the disk shape around the rotation shaft 17, and 12 blades 4 are connected to the hub portion 5. The number of blades is not limited to 12, and may be other multiples. The material of the fan 2 is a metal material such as an aluminum alloy or a resin material such as CFRP. The material of the fan 2 may be a combination of a plurality of materials. The blades 4 are arranged uniformly in the circumferential direction. When the fan 2 is viewed in a plan view from above, the projection planes of the blades 4 do not overlap one another.

The hub portion 5 is provided with twelve hole portions 6 penetrating in the vertical direction. The hole portions 6 are arranged uniformly in the circumferential direction.

The beam portions 10 each are provided between the hole portions 6. The fan 2 generates a thrust by rotating in the counterclockwise direction about the rotation shaft 17. The blade 4 includes the blade leading edge 7 and the blade trailing edge 8. FIG. 2 is the cross-sectional view taken along the line A-B in FIG. 1. As shown in FIG. 2, the side surface of the hole portion 6 has the sloped surface portion 11. The angle formed by the rotation direction 21 and the sloped surface portion 11 is an acute angle. In FIG. 2, the sloped surface portions 11 are provided on two side surfaces of the hole portion 6, but the sloped surface may be provided on only one side surface. This is because when the fan 2 rotates, air is taken in from the hole portions 6 to cool the motor 3 installed below the fan 2.

A blade circumferential region 15, which is a region occupied by a blade root 9 in the circumferential direction, largely overlaps a beam portion circumferential region 16, which is a region occupied by the beam portion 10 in the circumferential direction. That is, the entire blade 4 and one entire beam portion 10 are accommodated in a region OCD obtained by equally dividing the fan 2 by the number of the plurality of blades 4.

Next, effects of Embodiment 2 will be described. First, an effect shown in Embodiment 1 is also achieved in Embodiment 2. Other effects will be described. When the fan rotates, the blades 4 and the hub portion 5 are deformed by a centrifugal force generated in the blades 4 and the hub portion 5. Here, since the numbers of the blades 4 and the hole portions 6 are the same and the blades 4 and the hole portions 6 are installed at equal intervals in the circumferential direction, deformed states of the blades 4 are all the same. When the deformed states of the blades 4 are different, a possibility that axial vibration or the like occurs during fan rotation due to eccentricity or the like increases. However, in Embodiment 2, since the deformed states of the blades 4 are the same, the possibility is reduced. Further, in Embodiment 2, the blade circumferential region 15 largely overlaps the beam portion circumferential region 16. In this case, the centrifugal force generated in the blade 4 acts as a tensile force to the beam portion 10. If there is no overlapping region in the circumferential direction, a bending moment is applied to the beam portion 10 by the centrifugal force caused by the blade 4, but when the bending moment is applied, a stress generated at a corner portion of the beam portion 10 increases. However, in the case of the present embodiment, since the generation of the bending moment can be prevented, the stress generated at the corner portion of the beam portion 10 can be prevented, and the structural reliability of the fan can be improved.

These effects can also be achieved by setting the number of hole portions 6 to an integral multiple of the number of blades 4.

### SUMMARY

In Embodiment 2, the hub portion 5 has a plurality of hole portions 6 arranged at equal intervals in the circumferential direction of the hub portion 5, and the number of hole portions 6 is an integral multiple of the number of blades 4.

According to Embodiment 2 having the configuration as described above, since the deformed states of the plurality of blades 4 during the fan rotation are the same, it is possible to reduce the possibility that the axial vibration or the like occurs during the fan rotation.

Further, in Embodiment 2, in the fan 2, the number of the plurality of blades 4 and the number of the plurality of hole portions 6 are the same, and the entire blade 4 among the plurality of blades 4 and the entire beam portion 10, which is a portion of the hub portion 5 sandwiched between two adjacent hole portions 6 among the plurality of hole portions 6, are accommodated in the region OCD obtained by equally dividing the fan 2 by the number of the plurality of blades 4. Accordingly, the stress generated at the corner portion of the beam portion 10 can be prevented, and thus the structural reliability of the fan 2 can be improved.

### Embodiment 3

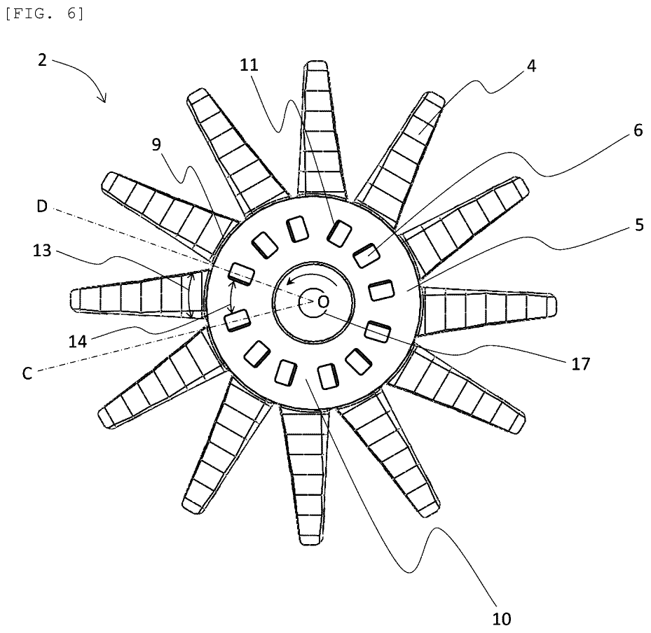

FIG. 6 is a top view of the fan 2 of the propulsion device 1 according to Embodiment 3 to be mounted on the flying object 18. The structure of the fan 2 in Embodiment 3 is basically the same as the fan structure of Embodiment 2. Hereinafter, only differences from Embodiment 2 will be described.

As described in Embodiments 1 and 2, in order to improve the cooling performance of the motor 3, it is considered effective to increase a size of the hole portion 6 provided in the hub portion 5. However, when the size of the hole portion 6 is increased, a width of the beam portion 10 in the circumferential direction is reduced. Here, as described in [Technical Problem], since the present propulsion device is characterized by rotating at a high speed, an excessive centrifugal force is generated. Therefore, when the width of the beam portion 10 is narrow, an excessive tensile stress may be generated in the beam portion 10 due to the centrifugal force, and the beam portion 10 may be damaged.

Therefore, in the present embodiment, when a cross-sectional area of a blade circumferential cross section 13, which is a cross section of the blade 4 in the circumferential direction at any radial position, is a, a mass of a blade outer peripheral portion, which is a portion of the blade 4 located on an outer peripheral side of the blade circumferential cross section 13, is m, a distance from a rotation center O of the rotation shaft 17 to a center of gravity of the blade outer peripheral portion is r, a stress concentration coefficient in the blade circumferential cross section 13 is Kb, the number of hole portions 6 (that is, the number of blades 4) is Z, a cross-sectional area of a beam portion circumferential cross section 14, which is a cross section of the beam portion 10 in the circumferential direction at any radial position, is A, a mass of a hub outer peripheral portion, which is a portion located on an outer peripheral side of the beam portion circumferential cross section 14 in the region OCD obtained by dividing the hub portion 5 into Z equal parts by planes OC and OD passing through the rotation center O, is M, a distance from the rotation center O to a combined center of gravity of the blade 4 and the hub outer peripheral portion is R, the stress concentration coefficient in the beam portion circumferential cross section is Kh, and an angular velocity of the fan 2 is ω, a stress σb generated in the blade circumferential cross section 13 can be simply expressed as follows, considering that the centrifugal force is dominant in an acting external force.

$${σ}_{b} = {K}_{b} \frac{mr {ω}^{2}}{a} \qquad [ Math . 1 ]$$

In general, the stress σb is maximized at the blade root 9.

The stress σh generated in the cross section of the beam portion 10 in the circumferential direction at any radial position can be simply expressed as follows, considering that the centrifugal force is dominant in the acting external force.

$${σ}_{h} = {K}_{h} \frac{m + M ) R {ω}^{2}}{A} \qquad [ Math . 2 ]$$

Here, in order to ensure strength reliability of the beam portion 10, the stress generated in the beam portion 10 may be equal to or less than the stress generated in the blade 4. Therefore, the following expression may be satisfied.

$$A \geq \frac{{K}_{h}}{{K}_{b}} \cdot ( \frac{m + M}{m} ) \cdot \frac{R}{r} \cdot a \qquad [ Math . 3 ]$$

### SUMMARY

In Embodiment 3, when the cross-sectional area of the blade circumferential cross section 13, which is a cross section in the circumferential direction at any radial position of one blade 4 among the plurality of blades 4, is a, the mass of the blade outer peripheral portion, which is the portion of the one blade 4 located on the outer peripheral side of the blade circumferential cross section 13, is m, the distance from the rotation center O of the rotation shaft 17 to the center of gravity of the blade outer peripheral portion is r, the stress concentration coefficient in the blade circumferential cross section 13 is Kb, the number of the plurality of blades 4 is Z, the cross-sectional area of the beam portion circumferential cross section 14, which is the cross section in the circumferential direction at any radial position of the beam portion 10 which is a portion of the hub portion 5 sandwiched between two adjacent hole portions among the plurality of hole portions 6, is A, the mass of the hub outer peripheral portion, which is the portion located on the outer peripheral side of the beam portion circumferential cross section 14 in the region OCD obtained by dividing the hub portion 5 into Z equal parts by the planes OC and OD passing through the rotation center O, is M, the distance from the rotation center O to the combined center of gravity of the one blade 4 and the hub outer peripheral portion is R, and the stress concentration coefficient in the beam portion circumferential cross section is Kh,

$$A \geq \frac{{K}_{h}}{{K}_{b}} \cdot ( \frac{m + M}{m} ) \cdot \frac{R}{r} \cdot a \qquad [ Math . 4 ]$$

is satisfied.

According to Embodiment 3 having the configuration as described above, since it is possible to prevent the excessive tensile stress from being generated in the beam portion 10, it is possible to ensure the strength reliability of the beam portion 10.

Although the embodiments of the invention have been described above, the invention is not limited to the above-described embodiments, and includes various modifications. For example, the embodiments described above have been described in detail in order to describe the invention in an easy-to-understand manner, and the invention is not necessarily limited to including all the described configurations. In addition, it is also possible to add a part of a configuration of a certain embodiment to a configuration of another embodiment, and it is also possible to delete a part of a configuration of a certain embodiment or replace a part of a configuration of another embodiment.

### REFERENCE SIGNS LIST

1: propulsion device
2: fan
3: motor
4: blade
5: hub portion
6: hole portion
7: blade leading edge
8: blade trailing edge
9: blade root
10: beam portion
11: sloped surface portion
12: frame portion
13: blade circumferential cross section
14: beam portion circumferential cross section
15: blade circumferential region
16: beam portion circumferential region
17: rotation shaft
18: flying object
19: loading portion
20: frame
21: rotation direction

1. A propulsion device comprising:
a motor;
a rotation shaft driven by the motor; and
a fan attached to the rotation shaft, wherein
the fan includes a hub portion attached to the rotation shaft and a plurality of blades provided at equal intervals on an outer periphery of the hub portion,
the hub portion has a plurality of hole portions arranged at equal intervals in a circumferential direction of the hub portion, and
at least a part of side surfaces of the plurality of hole portions is sloped with respect to a center axis of the rotation shaft.

2. The propulsion device according to claim 1, wherein
at least a part of side surfaces of the plurality of hole portions is sloped toward a rotation direction of the fan with respect to the center axis of the rotation shaft.

3. The propulsion device according to claim 1, wherein
a cross-sectional area of a beam portion, which is a portion of the hub portion sandwiched between two adjacent hole portions among the plurality of hole portions, in the circumferential direction of the hub portion is set such that a stress generated in the beam portion is smaller than a stress generated in the plurality of blades.

4. The propulsion device according to claim 1, wherein
the number of the plurality of hole portions is an integral multiple of the number of the plurality of blades.

5. The propulsion device according to claim 1, wherein
the number of the plurality of blades and the number of the plurality of hole portions are the same, and
one entire blade among the plurality of blades and an entire beam portion, which is a portion of the hub portion sandwiched between two adjacent hole portions among the plurality of hole portions, are accommodated in a region obtained by equally dividing the fan by the number of the plurality of blades.

6. The propulsion device according to claim 5, wherein
$$A \geq \frac{{K}_{h}}{{K}_{b}} \cdot ( \frac{m + M}{m} ) \cdot \frac{R}{r} \cdot a \qquad [ Math . 1 ]$$
is satisfied, in which
a is a cross-sectional area of a blade circumferential cross section, which is a cross section in the circumferential direction at any radial position of one blade among the plurality of blades,
m is a mass of a blade outer peripheral portion, which is a portion of the one blade located on an outer peripheral side of the blade circumferential cross section,
r is a distance from a rotation center of the rotation shaft to a center of gravity of the blade outer peripheral portion,
Kb is a stress concentration coefficient in the blade circumferential cross section,
Z is the number of the plurality of blades,
A is a cross-sectional area of a beam portion circumferential cross section, which is a cross section in the circumferential direction at any radial position of the beam portion, which is a portion of the hub portion sandwiched between two adjacent hole portions among the plurality of hole portions,
M is a mass of a hub outer peripheral portion, which is a portion located on an outer peripheral side of the beam portion circumferential cross section in a region obtained by dividing the hub portion into Z equal parts by a plane passing through the rotation center,
R is a distance from the rotation center to a combined center of gravity of the one blade and the hub outer peripheral portion, and
Kh is a stress concentration coefficient in the beam portion circumferential cross section.

7. The propulsion device according to claim 1, wherein
when the fan is projected onto a plane perpendicular to the rotation shaft, projection planes of two adjacent blades among the plurality of blades do not overlap each other.
